(19) United States
(12) Patent Application Publication
(10) Pub. No.: US 2008/0090186 A1
(43) Pub. Date: Apr. 17, 2008

(54) Method and system for performing development processing during photolithography

(75) Inventors: Masahiko Harumoto, Kyoto (JP); Akira Yamaguchi, Kyoto (JP); Akhiro Hisai, Kyoto (JP)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: SOKUDO CO., LTD., Kyoto (JP)

(21) Appl. No.: 11/906,760

(22) Filed: Oct. 2, 2007

(30) Foreign Application Priority Data
Oct. 4, 2006 (JP) 2006-272559

(51) Int. Cl. G03C 5/29

(52) U.S. Cl. 430/434; 134/56 R

(57) ABSTRACT

A method of eliminating an occurrence of concentration differences in a developer depending on position on a substrate surface when a developer on the substrate is replaced with a rinse, preventing occurrence of stain-like defects on a resist film surface, and reducing amount of the developer used is disclosed. While a substrate is being rotated about a vertical axis by a rotation motor while held in a horizontal posture by a spin chuck, after the developer has been fed onto the resist film on the substrate surface from a developer discharge nozzle to conduct processing, the substrate continues to be rotated and thus the developer on the resist film is dispersed and removed by a centrifugal force, and when an interference fringe seen on the substrate surface is reduced in level or not present, a rinse is fed onto the resist film from a rinse discharge nozzle to conduct rinsing.

### CROSS-REFERENCES TO RELATED APPLICATIONS

This application claims priority to Japanese Patent Application 2006-272559, filed Oct. 4, 2006, the disclosure of which is incorporated by reference in its entirety herein for all purposes.

### BACKGROUND OF THE INVENTION

The present invention relates to a substrate processing method and a substrate processing apparatus in which a developer is fed onto a resist film having been exposed and formed on the surface of a substrate such as semiconductor wafer, liquid crystal display glass substrate, photo-mask glass substrate, and optical disk substrate, to conduct processing.

In a conventional process of manufacturing a semiconductor device, a circuit pattern is formed on a resist film of a substrate employing lithography, for example, by the steps of applying a photo-resist on a silicon substrate, printing a circuit pattern onto a resist film on the substrate using an exposure device, and developing the resist film having been exposed with a developer. In the developing process among those steps, for example, while a substrate is being rotated in a vertical axis while held in a horizontal posture, a developer continues to be discharged onto the center of the substrate from a tip end outlet of a straight nozzle, and the developer is uniformly spread and applied over the entire surface of a resist film on the substrate surface, thereby developing the resist film having been exposed and formed on the substrate surface. In addition, recently, instead of the mentioned development method, such a development method has been widely used that with respect to a substrate in a still state of being held in the horizontal posture, while a slit nozzle having a slit-like outlet at the lower end face is being moved linearly in a direction orthogonal to the slit-like outlet, a developer is discharged onto a resist film on the substrate surface from the slit-like outlet, and the developer is spread forming a continuous film over the entire surface of the resist film, thereby developing the resist film (the so-called paddle phenomenon). The line width of a pattern to be formed on the resist film by these processing is controlled by adjusting the time period in which the developer continues to be discharged onto the substrate from the straight nozzle in the former development method, and by adjusting the time period of the developer being uniformly spread on the substrate in the paddle development. Therefore, in the former development method, when a predetermined discharge time period of the developer has elapsed, the supply of the developer onto the substrate is stopped; at the same time, a rinse (rinsing agent) such as a de-ionized water (DI water) is fed onto the resist film having been processed and formed on the substrate surface to conduct rinsing; and thereafter, the substrate is dried by spin-drying. Moreover, in the paddle development, for example, as disclosed in the Japanese Patent Publication (unexamined) No. 20508/1998, when a predetermined still time period after the developer has been uniformly spread (low-speed rotation time period when the substrate is rotated at low speed in the state that the developer is uniformly spread) has elapsed, the substrate is brought in rotation at high speed; a rinse is fed onto the substrate to conduct rinsing; and thereafter the substrate is dried by spin-drying.

In this respect, it has been conventionally considered that when there is a time period present between the development process and the rinsing process, a resin component of the resist having been dissolved into the developer remains on the resist film as scum, thereby leading to the occurrence of considerable development defects on the resist film. Therefore, in the paddle development as mentioned above, when a predetermined rest time period has elapsed after the developer has been uniformly spread, the substrate is rotated at high speed and, at the same time, the rinse is fed onto the substrate to conduct rinsing, thus to rapidly replace the developer on the resist film with the rinse. However, in a chemically amplified resist that has been widely used recently, there is reported no example in which the resin component of the resist having been dissolved into the developer becomes a scum; while, there are reported many problems such as the occurrence of stain-like defects (referred to as satellites or cat paws) on the resist film surface. The occurrence of these stain-like defects is caused by the remaining developer on the resist film, being caused by the generation of a concentration difference in the developer depending on the position on the substrate surface on the occasion when the program proceeds to the development process from the rinsing process, and thus the developer is replaced by the rinse, e.g., DI water. Accordingly, the method having been desirable heretofore, that is, the method itself of replacing the developer with the rinse immediately after the development process is thought to be problematic.

Furthermore, in the conventional concept, a time period until the developer on the substrate is replaced by the rinse, is considered a development time period. Thus, based on such a concept, the pattern line width of the resist film has been controlled by adjusting this time period. Accordingly, in the conventional development method, until going to the rinsing process, the developer continues to be discharged onto the resist film. Consequently, a large amount of developer has been used. Moreover, also in the paddle development, a sufficient amount of developer is to be spread on the resist film such that the development reaction reliably proceeds in the time period until the developer is replaced by the rinse on the substrate. Consequently, more developer than necessary is used for the development reaction.

### SUMMARY OF THE INVENTION

The present invention has been made in view of the situations as described above, and has an object of providing a substrate processing method by which the occurrence of a concentration difference in developer depending on the position on a substrate surface on the occasion when the developer on the substrate is replaced with a rinse (rinsing agent) is eliminated; thus, the occurrence of stain-like defects on the resist film surface can be prevented; and the amount of the developer used can be reduced. The invention also has another object of providing a substrate processing apparatus with which the mentioned method can be preferably carried out.

According to an embodiment of the present invention a substrate processing method is provided. The method includes a development process in which a developer is fed onto a resist film having been exposed and formed on a surface of the substrate to process the resist film; a rinsing process in which while the substrate is being rotated about the vertical axis in the horizontal posture, a rinse (rinsing agent) is fed onto the resist film having been processed and formed on the substrate surface; and a drying process in which the substrate is rotated about the vertical axis in the horizontal posture, to dry a resist film having been rinsed and formed on a substrate surface; and in which after the mentioned development process, the substrate is rotated about the vertical axis in the horizontal posture, thus a developer on the surface of the substrate is dispersed by a centrifugal force to be removed, and at a time point at which there is no interference fringe seen on the substrate surface, the operation goes to the mentioned rinsing process.

In an particular embodiment, in the development process, with respect to the substrate in a still state of being held in the horizontal posture or a substrate in rotation at low speed, while a slit nozzle having a slit-like outlet at a lower end face is being moved linearly in a direction orthogonal to the slit-like outlet, the developer is discharged onto the resist film on the substrate surface from the mentioned slit-like outlet, and thus the developer is spread forming a continuous film all over the surface of the resist film.

In another embodiment, in the development process, while the substrate is being rotated about the vertical axis in the horizontal posture, the developer is discharged onto the center of the substrate from the tip end outlet of the straight nozzle, and thus the developer is spread all over the surface of the resist film on the substrate surface to apply the developer; and the substrate continues to be rotated after the mentioned development process, and the developer on the surface of the substrate is dispersed by a centrifugal force to be removed.

In yet another particular embodiment, during the developer removing process, a drying gas is fed onto the center of the substrate in rotation, and a position of feeding the drying gas is scanned from a center of the substrate to a circumferential edge thereof.

In an alternative embodiment, in the developer removing process, a drying gas is fed onto the center of the substrate in rotation, and a position of feeding the drying gas is scanned from a center of the substrate to a circumferential edge thereof.

According to another embodiment of the present invention, a substrate processing apparatus is provided. The substrate processing apparatus includes a substrate holder configured to hold the substrate in a horizontal posture, a substrate rotation device configured to rotate the substrate on the substrate holder about a vertical axis, a developer discharge nozzle configured to discharge a developer onto a resist film having been exposed and formed on a surface of the substrate held by the mentioned substrate holder, and a rinse discharge nozzle configured to discharge a rinse onto a resist film having been processed that is formed on a substrate surface.

The substrate processing apparatus further includes an interference fringe detection system configured to image the surface of the substrate to detect the presence or absence of an interference fringe on the substrate surface from the imaged data thereof; and a control system configured to control each of the mentioned substrate rotation device, developer discharge nozzle, and rinse discharge nozzle such that after the developer has been discharged onto the resist film having been exposed and formed on the substrate surface from the mentioned developer discharge nozzle, to process the resist film, the substrate continues to be rotated, thus the developer on the surface of the substrate is dispersed by a centrifugal force to be removed, and at a time point at which there is no interference fringe detected (or the interference fringe is associated with a predetermined level) on the substrate surface by the mentioned interference fringe detection system, a rinse is discharged onto the resist film having been processed that is formed on the substrate surface from the mentioned rinse discharge nozzle to conduct rinsing.

In a specific embodiment, the mentioned developer discharge nozzle includes a slit nozzle having a slit-like outlet at a lower end face, and with respect to the substrate in a still state of being held by the mentioned substrate holder or the substrate in rotation at low speed, while being moved linearly in a direction orthogonal to the mentioned slit-like outlet, discharging the developer onto the resist film on the substrate surface from the mentioned slit-like outlet, to spread the developer forming a continuous film all over the surface of the resist film.

In another specific embodiment, the mentioned developer discharge nozzle includes a straight nozzle discharging the developer from the tip end outlet onto the center of the substrate that is held by the mentioned substrate holder and rotated at low speed by the mentioned substrate rotation device, to spread the developer all over the surface of the resist film on the substrate surface to apply the developer.

In yet another specific embodiment, the substrate processing apparatus also includes a gas jet nozzle blowing out a drying gas onto the resist film having been processed that is formed on the substrate surface.

In an alternative embodiment, the mentioned gas jet nozzle, while a drying gas is being blown out onto the surface of the substrate from a jet hole thereof, is scanned from a position in which the jet hole is opposed to the center of the substrate to a position in which it is opposed to the circumferential edge of the substrate.

As described throughout the specification, in some embodiments, since the substrate is rotated after the development process, the developer on the surface of the substrate is dispersed by a centrifugal force to be removed. Then, at the time point at which there is no interference fringe seen on the substrate surface, or the interference fringes are associated with a predetermined level, that is, at the time point at which less developer remains on the resist film on the substrate surface and thus the developer on the resist film comes to form a continuous thin film of a uniform film thickness, or at the time point at which there is no developer present on the resist film, the operation goes to the rinsing process. Therefore, less developer remains on the resist film on the substrate surface, or there will be no developer present on the resist film. In this state, when a rinse is fed onto the resist film on the substrate surface to conduct rinsing, the developer on the resist film is rapidly replaced with the rinse. Accordingly, since there will be a significantly less time period and region in which the concentration difference in the developer occurs depending on the position on a substrate surface, or since there is no developer on the resist film at a time point of starting the rinsing, the generation itself of the concentration difference in the developer depending on the position on the substrate surface does not occur. As a result, the occurrence of stain-like defects on the resist film surface caused by the remaining developer on the resist film is suppressed or eliminated.

Whereas, even if a less developer remains on the resist film on the substrate surface, due to the presence of the developer on the resist film, a development reaction still proceeds until the rinsing is conducted. Furthermore, even if there is no developer on the resist film, insofar as the developer is present in an internal part of the resist film, the development reaction still proceeds until the rinsing is conducted. Thus, in the former development method, also during the time period in which the substrate is rotated after the supply of the developer onto the resist film on the substrate surface has been stopped, the development reaction still proceeds. Accordingly, even if the developer does not continue to be fed onto the resist film on the substrate surface in a conventional fashion, by adjusting the time of going to the rinsing process, a pattern line width of the resist film can be controlled. Moreover, in the paddle development, the development reaction still proceeds even if more developer than necessary is not spread on the resist film, so that by adjusting the time of going to the rinsing process, the pattern line width of the resist film can be controlled.

As a result, according to the substrate processing method provided by embodiments of the present invention, the occurrence of stain-like defects on the resist film on the substrate surface can be prevented, and the amount used of the developer can be reduced.

In the processing method described herein, in the case of conducting the so-called paddle development, due to that the substrate in the still state or the substrate in rotation at low speed is further rotated or rotated at higher speed after the development process, the above-mentioned advantages are provided.

In other processing methods described herein, in the case where the developer is discharged onto the center of the substrate from the tip end outlet of the straight nozzle, due to that the substrate continues to be rotated after the development process, the above-mentioned advantages are provided.

In some embodiments, the processing methods provide, that due to that a drying gas being fed onto the center of the substrate in rotation, the film thickness of the developer is decreased at the center of the substrate. Therefore, the time period required to rotate the substrate after the development process to remove the developer from the surface of the substrate can be made shorter. As a result, in the processing method described herein, the time period necessary for a series of processing from the development process to the drying process can be shortened.

In the processing method described herein, due to that a drying gas is fed onto the center of the substrate in rotation, the film thickness of the developer at the center of the substrate comes to be smaller. In addition, due to that the position of feeding the drying gas is scanned from the center of the substrate to the circumferential edge, the film thickness of the developer is decreased by degrees from the center of the substrate toward the circumferential edge. Therefore, the time period required to rotate the substrate after the development process to remove the developer from the surface of the substrate can be made shorter. As a result, in the processing methods provided according to embodiments of the present invention, the time period necessary for a series of processing from the development process to the drying process can be shortened.

When using the substrate processing apparatus described herein, due to that after the developer has been discharged on the resist film on the substrate surface from the developer discharge nozzle and thus the resist film has been processed, the substrate continues to be rotated by the substrate rotation device, the developer on the surface of the substrate is dispersed by the centrifugal force to be removed. Then, in a particular embodiment, at the time point at which there is no interference fringe detected on the substrate surface by the interference fringe detection system, that is, at the time point at which less developer remains on the resist film on the substrate surface and thus the developer on the resist film comes to form a continuous thin film of a uniform film thickness, or at the time point at which there is no developer present on the resist film, the rinse is fed onto the resist film on the substrate surface from the rinse discharge nozzle to conduct rinsing. Therefore, a less developer remains on the resist film on the substrate surface, or there is no developer present on the resist film.

In this state, when a rinse is fed onto the resist film on the substrate surface from the rinse discharge nozzle to conduct rinsing, the developer on the resist film is rapidly replaced with the rinse. Accordingly, since there will be a significantly less time period and region in which the concentration difference in the developer occurs depending on the position on the substrate surface, or since there is no developer on the resist film at a time point of starting rinsing, the generation itself of the concentration difference in the developer depending on the position on the substrate surface does not occur. As a result, the occurrence of stain-like defects on the resist film surface caused by the remaining developer on the resist film is suppressed or eliminated.

Whereas, even if the substrate continues to be rotated by the substrate rotation device after processing and thus less developer remains on the resist film on the substrate surface, due to the presence of the developer on the resist film, a development reaction still proceeds until the rinsing is conducted. Furthermore, even if there is no developer on the resist film, insofar as the developer is present in an internal part of the resist film, the development reaction still proceeds until the rinsing is conducted. Thus, in the method of discharging the developer onto the center of the substrate from the tip end outlet of the straight nozzle to conduct the development, also during the time period of the substrate being rotated after the supply of the developer onto the resist film on the substrate surface has been stopped, the development reaction still proceeds. Accordingly, even if the developer does not continue to be fed onto the resist film on the substrate surface from the developer discharge nozzle, by adjusting the time of feeding the rinse onto the resist film on the substrate surface from the rinse discharge nozzle, a pattern line width of the resist film can be controlled. Further, in the paddle development, the development reaction still proceeds even if more developer than necessary is not spread on the resist film, so that by adjusting the time of feeding the rinse onto the resist film on the substrate surface from the rinse discharge nozzle, a pattern line width of the resist film can be controlled.

As a result, when using the substrate processing apparatus described herein, the processing methods of the present invention is preferably carried out, thus enabling prevention of the occurrence of stain-like defects on the resist film on the substrate surface, as well as to reduce the amount used of the developer.

In the processing apparatus described herein, in the case of conducting the so-called paddle development, due to that the substrate in the still state or the substrate in rotation at low speed is further rotated or rotated at higher speed after the development process, the above-mentioned advantages are provided.

In the processing apparatus described herein, in the case where the developer is discharged onto the center of the substrate from the tip end outlet of the straight nozzle to conduct development, due to that the substrate continues to be rotated after the development process, the above-mentioned advantages are provided.

In the processing apparatus described herein, due to that while the developer is being discharged onto the surface of the substrate from the outlet of the developer discharge nozzle, the developer discharge nozzle is scanned from the position in which the outlet thereof is opposed to the center of the substrate to the position in which it is opposed to the circumferential edge of the substrate, the film thickness of the developer is decreased by degrees from the center of the substrate toward the circumferential edge. Therefore, the time period required to rotate the substrate by the substrate rotation device after processing to remove the developer from the surface of the substrate can be made shorter. As a result, in the processing apparatus described herein, the time period necessary for a series of processing from the development process to the drying process can be shortened.

In the processing apparatus described herein, when a drying gas is fed onto the center of the substrate in rotation from the gas jet nozzle, the film thickness of the developer at the center of the substrate comes to be smaller. In addition, while the drying gas is being blown out onto the surface of the substrate from the jet hole of the gas jet nozzle, the gas jet nozzle is scanned from the position in which the jet hole thereof is opposed to the center of the substrate to the position in which it is opposed to the circumferential edge of the substrate, the film thickness of the developer is decreased by degrees from the center of the substrate toward the circumferential edge. Therefore, the time period required to rotate the substrate by the substrate rotation device after processing to remove the developer from the surface of the substrate can be made shorter. As a result, in the processing apparatus described herein, the time period necessary for a series of processing steps from the development process to the drying process can be shortened.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a schematic longitudinally sectional view illustrating one example of a construction of a processing apparatus for use in carrying out a substrate processing method according to the present invention.

FIG. 2 is a schematic plan view of the processing apparatus illustrated in FIG. 1.

FIG. 3 is a block diagram illustrating a part of a control system of the processing apparatus illustrated in FIG. 1.

FIG. 4 is a schematic longitudinally sectional view illustrating another construction example of a processing apparatus for use in carrying out a substrate processing method according to this invention.

FIG. 5 is a schematic plan view of the processing apparatus illustrated in FIG. 3.

FIG. 6 is a schematic plan view illustrating a yet further construction example of a processing apparatus for use in carrying out a substrate processing method according to this invention.

FIG. 7 is a sectional view taken along the line VII-VII indicated by the arrows in FIG. 6.

FIG. 8 is a sectional view taken along the line VIII-VIII indicated by the arrows in FIG. 6.

FIG. 9 is a graphic chart showing the change in the number of defects in the case of changing the time period of rotation of a substrate until going to a rinsing process when the substrate continues to be rotated after a development process to remove the developer.

### DETAILED DESCRIPTION OF SPECIFIC EMBODIMENTS

The best mode for carrying out the present invention is hereinafter described referring to the accompanying drawings.

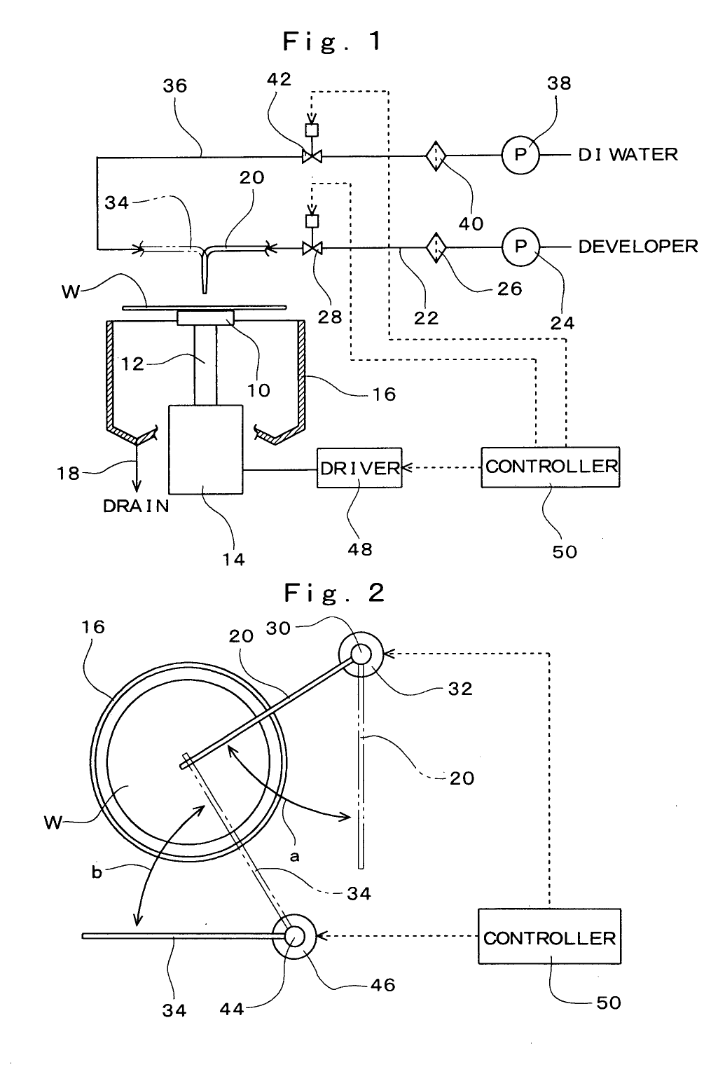

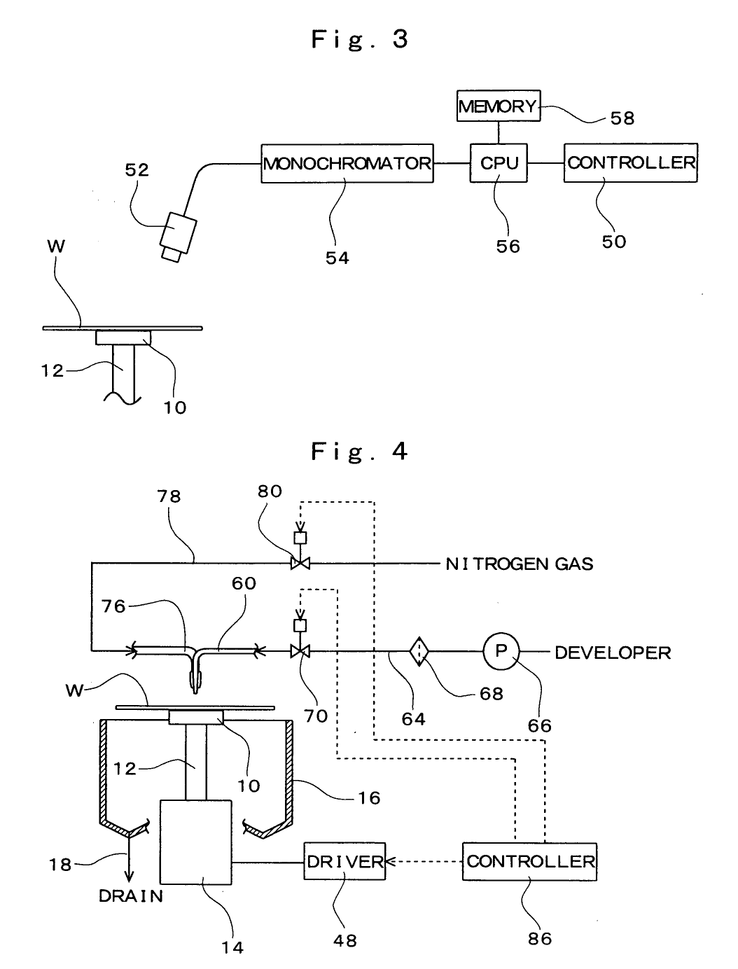

FIGS. 1 to 3 illustrate one example of construction of a processing apparatus for use in carrying out a substrate processing method according to embodiments of the present invention. FIG. 1 is a longitudinally sectional view illustrating a schematic construction of a processing apparatus, FIG. 2 is a plan view thereof, and FIG. 3 is a block diagram illustrating a part of a control system thereof.

This processing apparatus includes a spin chuck 10 holding a substrate W in a horizontal posture, a spindle 12 to the upper end of which the spin chuck 10 is fixed and which is vertically supported, and a rotation motor 14 of which rotary shaft is connected to the spindle 12 and which causes the spin chuck 10 and the spindle 12 to rotate about a vertical axis. There is disposed around the spin chuck 10 a circular cup 16 so as to surround the substrate W on the spin chuck 10. The cup 16 is supported so as to be capable of reciprocating in a vertical direction by a support mechanism, not illustrated. A drain tube 18 is connected in communication to the bottom of the cup 16.

There is disposed in the vicinity of the cup 16 a developer discharge nozzle 20 formed of a straight nozzle discharging a developer onto the substrate W from an outlet at a tip end. The developer discharge nozzle 20 is channel-connected to a developer supply source through a developer feed tube 22, and a pump 24, a filter 26 and a switching control valve 28 are interposed in this developer feed tube 22. The developer discharge nozzle 20 is held by a nozzle holding part 30 rotatably in a horizontal plane, and is turned in the horizontal plane by a rotation drive mechanism 32. Furthermore, the developer discharge nozzle 20, as indicated by the arrow a in FIG. 2, is constructed so as to reciprocate between a waiting position indicated by the two-dot chain line and being out of place to the outside from the cup 16, and a discharge position indicated by the solid line in which the outlet is located right above the center of the substrate W. In the state that the outlet is located right above the center of the substrate W as indicated by the solid line, the developer is discharged from the tip end outlet onto the surface center of the substrate W.

In addition, there is disposed in the vicinity of the cup 16 a DI water discharge nozzle 34 discharging a rinse (rinsing agent), for example, DI water onto the substrate W from the outlet at a tip end. The DI discharge nozzle 34 is channel-connected to a DI water supply source through a DI water feed tube 36, and a pump 38, a filter 40 and a switching control valve 42 are interposed in this DI water feed tube 36. The DI water discharge nozzle 34 is held by a nozzle holding part 44 rotatably in a horizontal plane, and is turned in the horizontal plane by a rotation drive mechanism 46. Further, the DI water discharge nozzle 34, as indicated by the arrow b in FIG. 2, is constructed so as to reciprocate between a waiting position indicated by the solid line and being out of place to the outside from the cup 16, and a discharge position indicated by the two-dot chain line in which the outlet is located right above the center of the substrate W. In the state that the outlet is located right above the center of the substrate W as indicated by the two-dot chain line, the DI water is discharged onto the surface center of the substrate W from the tip end outlet.

Moreover, this processing apparatus is provided with a controller 50 acting to control respective switching operations of the switching control valves 28 and 42, to control respective rotation drive mechanisms 32 and 46 of the developer discharge nozzle 20 and the DI water discharge nozzle 34, or further to control a driver 48 of the rotation motor 14 to adjust the number of revolutions of the rotation motor 14 and thus the rotation speed of the substrate W. Furthermore, this processing apparatus, as illustrated in FIG. 3, includes a CCD camera 52 for imaging the surface of the substrate W, and a monochromator 54 for collecting monochromatic light of a predetermined wavelength component from the image having been taken by the CCD camera 52 to convert it into an image data showing only light and shade (intensity of light). The monochromator 54 is connected to a CPU 56, and a memory 58 is connected to the CPU 56. In addition, the CPU 56 is connected to the mentioned controller 50. In the memory 58, a threshold value is stored with which it is determined whether or not there is an interference fringe on the surface of the substrate W. In the CPU 56, an intensity data of light having been transmitted from the monochromator 54 and the threshold value having been read out from the memory 58 are compared, and when it is determined that there is no interference fringe on the surface of the substrate W, or that the interference fringe has been reduced to a predetermined level, a signal is transmitted from the CPU 56 to the controller 50. More specifically, at the time point at which a fluctuating range (distribution) of light intensity in each position on the surface of the substrate W is within a predetermined range, or at the time point at which the value of light intensity at all positions on the surface of the substrate W is within a reference value having previously been set, the signal is transmitted from the CPU 56 to the controller 50. Then, in response to a control signal to be outputted from the controller 50, operations of the rotation drive mechanism 46 of the DI water discharge nozzle 34, the switching control valve 42 provided in the DI water feed tube 36 and the like are controlled.

Now, one example of a processing operation by means of the processing apparatus illustrated in FIGS. 1 to 3 is described.

When the substrate W on the surface of which a resist film having been exposed is formed, is held by the spin chuck 10, the developer discharge nozzle 20 is turned, and thus the tip end outlet of the developer discharge nozzle 20 is moved to the position right above the center of the substrate W. Then, while the substrate W is being rotated at a rotation speed of, for example, 500 rpm to 1,000 rpm, a developer is discharged and fed onto the center of the substrate W from the tip end outlet of the developer discharge nozzle 20. The developer having been fed onto the substrate W is spread over the entire surface of the substrate W to be applied onto the resist film so as to cover the entire surface of the resist film. After a predetermined time period has elapsed, for example, five to ten seconds have elapsed, the supply of the developer onto the substrate W is stopped, and the developer discharge nozzle 20 is turned to the original waiting position indicated by the two-dot chain line in FIG. 2 to be returned. On the other hand, even after the supply of the developer onto the substrate W has been stopped, the substrate W continues to rotate. For example, for 30 seconds when the substrate W is rotated at a rotation speed of 1,000 rpm, 60 seconds when the substrate W is rotated at a rotation speed of 500 rpm, and 90 seconds to 120 seconds when the substrate W is rotated at a rotation speed of 300 rpm, the substrate W continues to rotate. At this time, it is preferable that immediately after the supply of the developer onto the substrate W has been stopped, the substrate W is rotated at high speed, for example, at a rotation speed of 2,000 rpm to 3,000 rpm, only for a short time period, for example, for only one second, and thereafter switched to rotate at low speed, for example, at a rotation speed of 300 rpm to 500 rpm. Incidentally, during the rotation of the substrate W, the cup 16 is lifted.

After the supply of the developer onto the substrate W has been stopped to end the development process, the substrate W continues to be rotated even after the development process, whereby the developer on the surface of the substrate W is dispersed by a centrifugal force to be removed. Then, at the time point at which there is no interference fringe seen on the surface of the substrate W, or when the interference fringes are characterized by a predetermined level, that is, at the time point at which no or a reduced interference fringe is detected on the surface of the substrate W by an interference fringe detecting mechanism that is formed of the CCD camera 52, the monochromator 54, the CPU 56 and the memory 58 as mentioned above, while the substrate W further continues to be rotated, the DI water discharge nozzle 34 is turned, and the outlet at the tip end of the DI water discharge nozzle 34 is moved to the position right above the center of the substrate W. Subsequently, while the substrate W is being rotated, the DI water is discharged and fed onto the center of the substrate W from the tip end outlet of the DI water discharge nozzle 34. At the time point of going to this rinsing process, less developer remains on the resist film on the surface of the substrate W, and thus the developer on the resist film forms a continuous thin film of a uniform film thickness, or there is no developer present on the resist film. The rinsing is conducted for about 10 seconds to 15 seconds while the substrate W is being rotated at a rotation speed of, for example, 1,000 rpm. At this time, it is preferable that the substrate W is rotated at high speed for a moment shortly after the start of rinsing, and thereafter rotated at a reduced speed. With such operation, more impurities are flowed out from the resist film. When the rinsing process is ended, the supply of the DI water onto the substrate W is stopped, and the DI water discharge nozzle 34 is turned and returned to the original waiting position indicated by the solid line in FIG. 2. Then, the rotation speed of the substrate W is switched to high speed, to dry the substrate W by spin-drying. On this occasion, the cup 16 is lifted. When the drying of the substrate W is ended, the substrate W is removed from the spin chuck 10 to be transported out of the apparatus.

As mentioned above, in embodiments in which no interference fringe is detected on the surface of the substrate W and thus less developer remains on the resist film on the surface of the substrate W, or there is no developer present on the resist film, the DI water is fed onto the resist film on the surface of the substrate W to be subjected to the rinsing, the developer on the resist film is to be rapidly replaced with the DI water. Therefore, since there is significantly less time period and region in which the concentration difference of the developer occurs depending on the position on the substrate surface, or since there is no developer on the resist film at a time point of starting rinsing, the generation itself of the concentration difference in the developer depending on the position on the substrate surface does not occur. As a result, the occurrence of stain-like defects on the resist film surface caused by the remaining developer on the resist film can be prevented.

Whereas, even if a less developer remains on the resist film on the surface of the substrate W, due to the presence of the developer on the resist film, a development reaction still proceeds until the DI water is fed onto the resist film to make rinsing. Furthermore, even if there is no developer on the resist film, insofar as the developer is present in an internal part of the resist film, the development reaction still proceeds until the rinsing is conducted. Thus, also during the time period in which the substrate W is in rotation after the development process, the development reaction still proceeds. Accordingly, even if the developer does not continue to be fed onto the resist film in a conventional fashion, by adjusting the time of going to the rinsing process, a pattern line width of the resist film can be controlled.

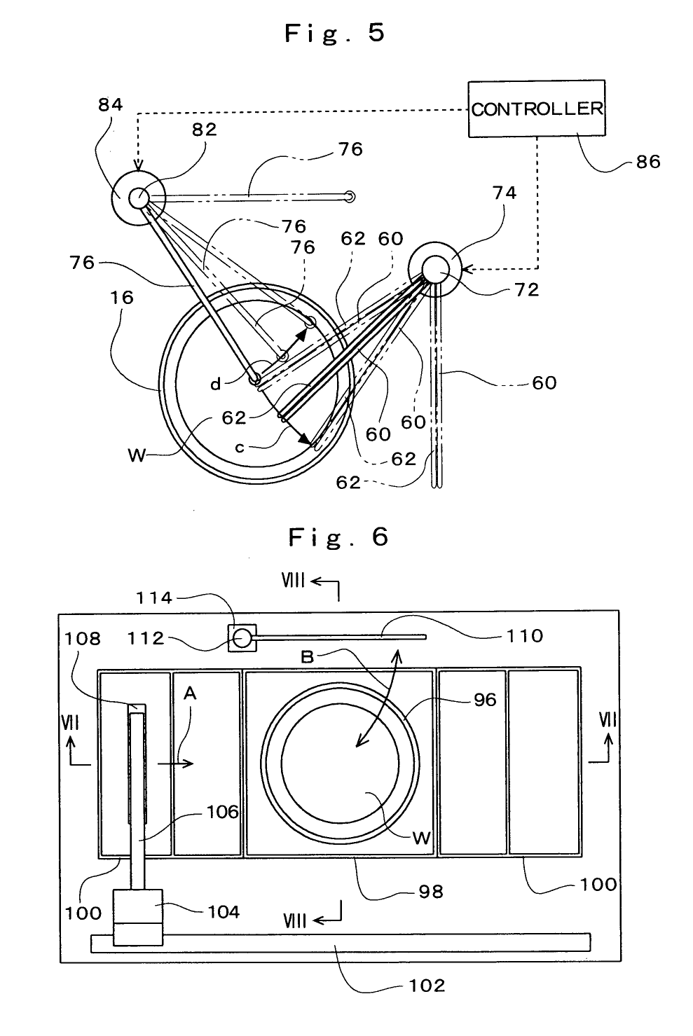

FIG. 5 is a graphic chart showing the change in the number of defects in the case of changing the time period of rotation of a substrate until going to the rinsing process when the substrate continues to be rotated after the development process to remove the developer. Test conditions are the rotation speed of the substrate at the time of processing: 300 rpm to 500 rpm; the rotation speed of the substrate after processing: 300 rpm to 500 rpm; the time period of discharge of a rinse (DI water): 10 seconds; the rotation speed of the substrate at the time of rinsing: 1,000 rpm; a drying time period of the substrate by spin-drying: 10 seconds; and the rotation speed of the substrate at the time of drying: 4,000 rpm. As seen from the results shown in FIG. 5, when rinsing is conducted without rotation of the substrate to remove the developer after processing the number of defects was tens of thousands; while, when the substrate is rotated for 60 seconds to 120 seconds after the processing, the number of defects was significantly reduced (350 numbers to 660 numbers). Incidentally, when the substrate is rotated for too long time period after processing, as compared with the case where the substrate is rotated only for an appropriate time period, the number of defects is increased. The time point at which the substrate has been rotated for 60 seconds to 120 seconds after the processing corresponds to the time point at which there is no interference fringe seen on the substrate surface. Accordingly, by going to the rinsing process at the time point at which there is no interference fringe seen on the substrate surface, the number of defects can be significantly decreased.

Additionally, although in the above-mentioned embodiment, in the development process, the tip end outlet of the developer discharge nozzle 20 is moved to the position right above the center of the substrate W to be stopped, and the developer is discharged and fed onto the center of the substrate W from tip end outlet of the developer discharge nozzle 20, it is preferable that while the developer is being discharged onto the surface of the substrate W from the outlet of the developer discharge nozzle 20, the developer discharge nozzle 20 is scanned from the position in which the outlet thereof is opposed to the center of the substrate W to the position in which it is opposed to a circumferential edge of the substrate W. By making such processing operation, a film thickness of the developer is decreased by degrees from the center of the substrate W toward the circumferential edge. Therefore, the time period required to rotate the substrate W to remove the developer from the surface of the substrate W after the development process, can be made shorter, thus enabling to shorten a time period necessary for a series of processing from the development process to the drying process. In addition, it is preferable that while the developer is being discharged onto the surface of the substrate W from the outlet of the developer discharge nozzle 20, the developer discharge nozzle 20 is scanned from the position in which the outlet thereof is opposed to the circumferential edge of the substrate W to the position in which it is opposed to the center of the substrate W; and thereafter the developer discharge nozzle 20 is scanned from the position in which this outlet is opposed to the center of the substrate W to the original position in which it is opposed to the circumferential edge of the substrate W. Likewise, it is preferable that while the developer is being discharged onto the surface of the substrate W from the outlet of the developer discharge nozzle 20, the developer discharge nozzle 20 is scanned from the position in which the outlet thereof is opposed to the circumferential edge of the substrate W to, through the position in which it is opposed to the center of the substrate W, and to the position in which it is opposed to the circumferential edge of the substrate W. Moreover, it is preferable that the rotation speed of the substrate is changed for each process, or is changed in one process.

Now, FIGS. 4 and 5 illustrate another construction example of a processing apparatus for use in carrying out a substrate processing method according to the invention. FIG. 4 is a longitudinally sectional view illustrating a schematic construction of the processing apparatus, and FIG. 5 is a plan view thereof. In FIGS. 4 and 5, components and members designated by the same reference numerals as those in FIGS. 1 and 2 have the same functions and operations as those of the above-mentioned components and members described in FIGS. 1 and 2, and further descriptions thereof are omitted.

In this processing apparatus, there are disposed in the vicinity of the cup 16 a developer discharge nozzle 60 that is formed of a straight nozzle discharging a developer onto a substrate W from an outlet at a tip end, and a DI water discharge nozzle 62 (not illustrated in FIG. 4) discharging a rinse, for example, a DI water onto the substrate W from an outlet at a tip end. The developer discharge nozzle 60 is channel-connected to a developer supply source through a developer feed tube 64, and a pump 66, a filter 68 and a switching control valve 70 are interposed in the developer feed tube 64. Furthermore, the DI water discharge nozzle 62, not illustrated, is channel-connected to a DI water supply source through a DI water feed tube, and a pump, a filter and a switching control valve are interposed in the DI water feed tube (refer to FIG. 1). The developer discharge nozzle 60 and the DI water discharge nozzle 62 are held by a common nozzle holding part 72 rotatably in a horizontal plane, and are made to turn in the horizontal plane by a rotation drive mechanism 74. Further, the developer discharge nozzle 60, while the developer is being discharged onto the surface of the substrate W from the outlet at the tip end, as illustrated by the arrow c in FIG. 5, is scanned from the position in which the outlet is opposed to the center of the substrate W to the position in which it is opposed to the circumferential edge of the substrate W. Moreover, the developer discharge nozzle 60 and the DI water discharge nozzle 624 are returned to a waiting position out of place to the outside from the cup 16 as indicated by the two-dot chain line.

Moreover, there is disposed in the vicinity of the cup 16 a gas jet nozzle 76 blowing out a drying gas, for example, nitrogen gas onto the substrate W from a jet hole at a tip end. The gas jet nozzle 76 is channel-connected to a nitrogen gas supply source through a gas feed tube 76, and a switching control valve 80 is interposed in the gas feed tube 78. The gas jet nozzle 76 is held by a nozzle holding part 82 rotatably in a horizontal plane, and is made to turn in the horizontal plane by a rotation drive mechanism 84. In addition, the gas jet nozzle 76, while the nitrogen gas is being blown out onto the surface of the substrate W from the jet hole at the tip end, as indicated by the arrow d in FIG. 5, is scanned from the position in which the jet hole is opposed to the center of the substrate W to the position in which it is opposed to the circumferential edge of the substrate W. Furthermore, the gas jet nozzle 76 is constructed so as to reciprocate between a waiting position out of place to the outside from the cup 16 as indicated by the two-dot chain line, and a position in which the jet hole is located right above the center of the substrate W.

In addition, this processing apparatus is provided with a controller 86 acting to control respective switching operations of the switching control valves 70 and 80, to control both of the rotation drive mechanism 74 for the developer discharge nozzle 60 and DI water discharge nozzle 62 and the rotation drive mechanism 84 of the gas jet nozzle 76, and further to control a driver 48 of the rotation motor 14 to adjust the number of revolutions of the rotation motor 14 and thus the rotation speed of the substrate. Furthermore, this processing apparatus, although not illustrated, in the same manner as in the apparatus illustrated in FIGS. 1 to 3, includes a CCD camera for imaging the surface of the substrate W, and a monochromator for fetching a monochromatic light of a required wavelength component from the image having been taken by the CCD camera to convert it into an image data showing the intensity of light. The monochromator is connected to a CPU, and a memory is connected to the CPU (refer to FIG. 3). In addition, the CPU is connected to the controller 86. In the CPU, an intensity data of light having been transmitted from the monochromator and the threshold value having been read out from the memory are compared, and when it is determined there is no interference fringe on the surface of the substrate W, or the amplitude of the interference fringes is reduced to a predetermined level, a signal is transmitted from the CPU to the controller 86. Then, in response to a control signal to be outputted from the controller 86, operations of the rotation drive mechanism 72 of the DI water discharge nozzle 62 (and the developer discharge nozzle 60), the switching control valve provided in the DI water feed tube and the like are controlled.

Now, one example of a processing operation by means of the processing apparatus illustrated in FIGS. 4 and 5 are described.

When the substrate W on the surface of which the resist film having been exposed is formed is held by the spin chuck 10, the developer discharge nozzle 60 (and the DI water discharge nozzle 62) is turned, and the tip end outlet of the developer discharge nozzle 60 is moved to the position right above the center of the substrate W. Then, the substrate W is brought in rotation at low speed, for example, at a rotation speed of 500 rpm to 1,000 rpm, and while the developer is being discharged onto the surface of the substrate W from the tip end outlet of the developer discharge nozzle 60, the developer discharge nozzle 60 is scanned from the position in which the outlet thereof is opposed to the center of the substrate W to the position in which it is opposed to the circumferential edge of the substrate W. Then, when the outlet of the developer discharge nozzle 60 has reached the position in which the outlet is opposed to the circumferential edge of the substrate W, the supply of the developer onto the substrate W is stopped, and the developer discharge nozzle 60 (and the DI water discharge nozzle 62) is turned and returned to the original waiting position indicated by the two-dot chain line in FIG. 5.

Whereas, even after the supply of the developer onto the substrate W has been stopped, in the same manner as in the above-mentioned apparatus illustrated in FIGS. 1 to 3, the substrate W continues to rotate. By this operation, the developer on the surface of the substrate W is dispersed by a centrifugal force to be removed. Further, the gas jet nozzle 76 is turned, and the jet hole of the gas jet nozzle 76 is moved to the position right above the center of the substrate W. Then, while a nitrogen gas is being blown out onto the substrate W from the jet hole of the gas jet nozzle 76, the gas jet nozzle 76 is scanned from the position in which the jet hole thereof is opposed to the center of the substrate W to the position in which it is opposed to the circumferential edge of the substrate W. In this manner, due to that while the nitrogen gas is being blown out onto the surface of the substrate W from the jet hole of the gas jet nozzle 76, the gas jet nozzle 68 is scanned from the position in which the jet hole thereof is opposed to the center of the substrate W to the position in which it is opposed to the circumferential edge of the substrate W, the film thickness of the developer on the resist film is decreased from the center of the substrate W toward the circumferential edge. Therefore, the time period required to remove the developer from the resist film becomes shorter. When the jet hole of the gas jet nozzle 76 has reached the position of being opposed to the circumferential edge of the substrate W, the supply of the nitrogen gas from the gas jet nozzle 76 onto the substrate W is stopped, and the gas jet nozzle 76 is turned and returned to the original waiting position indicated by the two-dot chain line in FIG. 5.

Due to that after the supply of the developer onto the substrate W has been stopped to end the development process, the substrate W continues to be rotated after the development process, the developer on the surface of the substrate W is dispersed by the centrifugal force to be removed. Then, at the time point at which there is no interference fringe seen on the surface of the substrate W, that is, at the time point at which no interference fringe (or a predetermined interference fringe pattern) is detected on the surface of the substrate W by an interference fringe detecting mechanism that is formed of the CCD camera, the monochromator, the CPU and the memory as mentioned above, while the substrate W continues to be rotated, for example, while the substrate W is being rotated at a rotation speed of 1,000 rpm, the DI water discharge nozzle 62 (and the developer discharge nozzle 60) is turned, the tip end outlet of the DI water discharge nozzle 62 is moved to the position right above the center of the substrate W, and the DI water is discharged and fed onto the center of the substrate W from the tip end outlet of the DI water discharge nozzle 62. When the rinsing process is ended, the supply of the DI water onto the substrate W is stopped, and then the DI water discharge nozzle 62 (and the developer discharge nozzle 60) is turned and returned to the original position indicated by a chain double-dashed line in FIG. 5. Further, the rotation speed of the substrate W is switched to high speed, to dry the substrate W by spin-drying. On this occasion, the cup 16 is lifted. When drying of the substrate is ended, the substrate W is removed from the spin chuck 10 to be transported out of the apparatus.

Also in the processing apparatus illustrated in FIGS. 4 and 5, in the state that less developer remains on the resist film on the surface of the substrate W or that there is no developer present on the resist film, the DI water is fed onto the resist film on the surface of the substrate W to conduct rinsing. Thus, in the same manner as in the apparatus illustrated in FIGS. 1 to 3, the occurrence of stain-like defects on the resist film surface caused by the remaining developer on the resist film is prevented. In addition, even if the developer does not continue to be fed onto the resist film, by adjusting the time of going to the rinsing process, a pattern line width of the resist film can be controlled. Moreover, in the processing apparatus illustrated in FIGS. 4 and 5, due to that the substrate W is rotated after the processing, the time period required to remove the developer from the resist film can be made shorter, so that a throughput can be improved.

Incidentally, although in the above-mentioned embodiment, in the development process, while the developer is being discharged onto the surface of the substrate W from the outlet of the developer discharge nozzle 60, the developer discharge nozzle 60 is scanned from the position in which the outlet thereof is opposed to the center of the substrate W to the position in which it is opposed to the circumferential edge of the substrate W, it is preferable that the tip end outlet of the developer discharge nozzle 60 is moved to the position right above the center of the substrate W to be stopped, and the developer is discharged and fed onto the center of the substrate W from the tip end outlet of the developer discharge nozzle 60. In addition, although while the nitrogen gas is being blown out onto the surface of the substrate W from the jet hole of the gas jet nozzle 76, the gas jet nozzle 76 is scanned from the position in which the jet hole thereof is opposed to the center of the substrate W to the position in which it is opposed to the circumferential edge of the substrate W, it is preferable that the jet hole of the gas jet nozzle 76 is moved to the position right above the center of the substrate W to be stopped, and the nitrogen gas is blown out just for a moment onto the center of the substrate W, or continues to be blown out. Furthermore, it is preferable that the timing in which the nitrogen gas starts to be blown out onto the surface of the substrate W from the gas jet nozzle 76 is before the outlet of the developer discharge nozzle 60 has reached the position opposed to the circumferential edge of the substrate W to stop the supply of the developer onto the substrate W. In addition, it is preferable that the speed of scanning of the developer discharge nozzle 60 and the gas jet nozzle 76 is constant, or varied. For example, it is preferable that the speed of the developer discharge nozzle 60 is gradually decreased or reduced stepwise as the developer discharge nozzle 60 is moved from the center position of the substrate to the circumferential edge position.

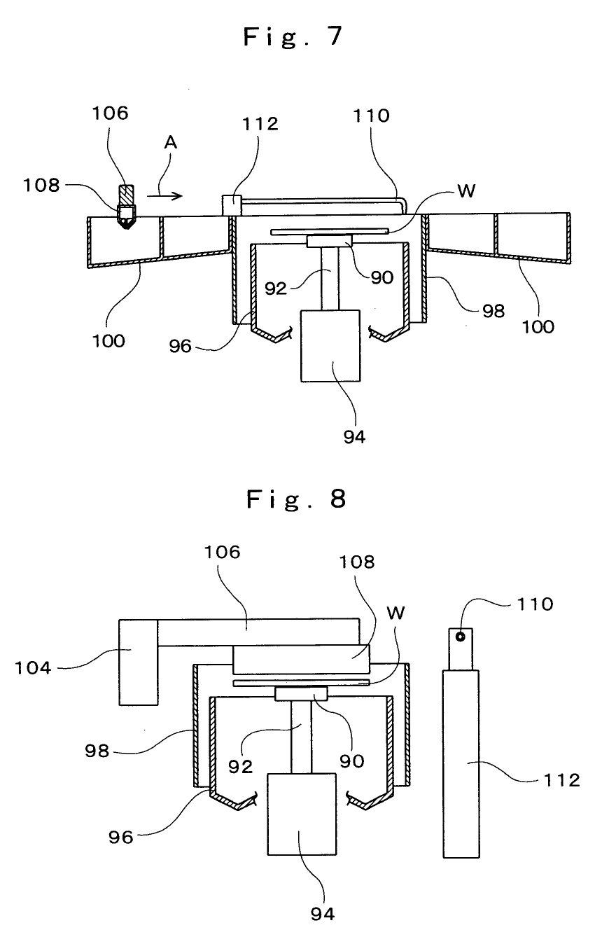

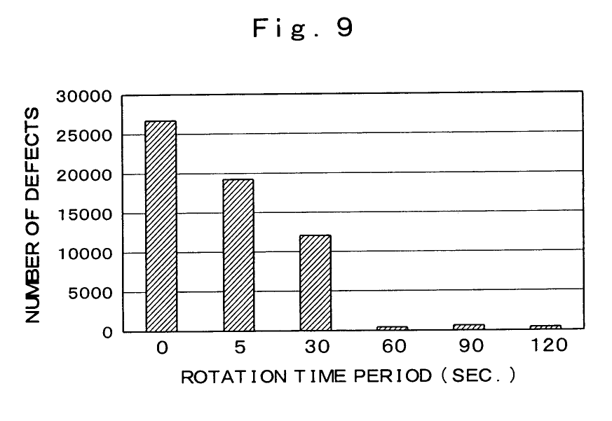

Now, FIGS. 6 to 8 illustrate a yet further construction of a processing apparatus for use in carrying out a substrate processing method according to this invention. FIG. 6 is a plan view illustrating a schematic construction of the processing apparatus. FIG. 7 is a sectional view taken along the line VII-VII indicated by the arrows. FIG. 8 is a sectional view taken along the line VIII-VIII indicated by the arrows in FIG. 6.

In this processing apparatus, at the central portion of the apparatus where processing of the substrate W is conducted, there are disposed a spin chuck 90 holding the substrate W in a horizontal posture, a spindle 92 to the upper end of which the spin chuck 90 is fixed and which is vertically supported, and a rotation motor 94 of which rotary shaft is connected to the spindle 92 and which causes the spindle 92 to rotate about the vertical axis. There is disposed around the spin chuck 90 a circular inside cup 96 so as to surround the substrate W on the spin chuck 90, and this inside cup 96 is supported so as to be capable of reciprocating vertically by a support mechanism not illustrated. There is disposed around the inside cup 96 a rectangular outside cup 98.

There are disposed on both left and right sides of the outside cup 98 respective waiting pots 100 and 100. On one side of the outside cup 98 and the waiting pots 100, a guide rail 102 is disposed in parallel to the connection direction of the outside cup 98 and the waiting pots 100. An arm drive 104 is engaged with the guide rail 102 slidingly, and a nozzle arm 106 is held by the arm drive 104. To the nozzle arm 106, a developer discharge nozzle 108 is attached by suspending from above in a horizontal posture. The developer discharge nozzle 108, although a detailed construction illustration is omitted, includes a slit-like outlet extending in a longitudinal direction at a lower end face. To the developer discharge nozzle 108, a developer feed tube (not illustrated) that is channel-connected to a developer supply source is communicated. This developer discharge nozzle 108 is disposed in a direction orthogonal to the guide rail 102. In addition, it is constructed such that by means of the arm drive 104, the nozzle arm 106 is linearly reciprocated in the horizontal direction along the guide rail 102, and thus the developer discharge nozzle 108 can be scanned in the direction indicated by the arrow A and returned in a direction opposite thereto.

Further, there is disposed in the vicinity on the rear side of the outside cup 98 a DI water discharge nozzle 110 discharging a rinse, for example, a DI water onto the substrate W from an outlet at a tip end. The DI water discharge nozzle 110 is channel-connected to a DI water supply source through a DI water feed tube not illustrated. The DI water discharge nozzle 110 is held by a nozzle holding part 112 pivotally in the horizontal plane, and turned in the horizontal plane in a direction indicated by the arrow B by a rotation drive mechanism 114. Furthermore, the DI water discharge nozzle 110 is constructed so as to reciprocate between a waiting position illustrated in FIG. 6 and a discharge position in which an outlet at a tip end is located right above the center of the substrate W.

Furthermore, this processing apparatus, although not illustrated, is provided with a controller acting to control respective switching control valves interposed in the developer feed tube and the DI water feed tube, to control respective arm drive 104 and rotation drive mechanism 114 of the DI water discharge nozzle 110, and further to control a driver of the rotation motor 94 to adjust the number of revolutions of the rotation motor 94 and thus the rotation speed of the substrate W. Furthermore, this processing apparatus, not illustrated, in the same manner as in the apparatus illustrated in FIGS. 1 to 3, includes a CCD camera for imaging the surface of the substrate W, and a monochromator for collecting a monochromatic light of a predetermined wavelength component from the image having been taken by the CCD camera to convert it into an image data showing the intensity of light. The monochromator is connected to a CPU, and a memory is connected to the CPU (refer to FIG. 3). In addition, the CPU is connected to the controller. In the CPU, an intensity data of light having been transmitted from the monochromator and the threshold value having been read out from the memory are compared, and when it is determined there is no interference fringe on the surface of the substrate W, a signal is transmitted from the CPU to the controller. Then, in response to a control signal to be outputted from the controller, the operations of the rotation drive mechanism 114 of the DI water discharge nozzle 110, the switching control valve provided in the DI water feed tube and the like are controlled.

Now, one example of processing operation by means of the processing apparatus illustrated in FIGS. 6 to 8 is described.

When the substrate W on the surface of which the resist film having been exposed is formed is transported into the apparatus, and the substrate W is held by the spin chuck 90, while the developer is being discharged from the slit-like outlet of the developer discharge nozzle 108, the developer discharge nozzle 108 is scanned in the direction indicated by the arrow A by the arm drive 104. Thus, the developer is fed to spread uniformly on the substrate W. When the developer discharge nozzle 108 has moved to the position of the right-side waiting pot 100, the discharge of the developer is stopped, the developer discharge nozzle 108 is moved in the direction opposite to the direction indicated by the arrow A by the arm drive 104, and the developer discharge nozzle 108 is returned to the original position of the left-side waiting pot 100. Then, the substrate W is kept still until a predetermined time period has elapsed since the developer being uniformly spread on the substrate W, to develop the resist film on the surface of the substrate W.

When a predetermined time period, for example, 60 seconds have elapsed since the developer being uniformly spread on the substrate W, the substrate W is rotated at the rotation speed of, for example, 300 rpm to 1,000 rpm. At this time, it is preferable that immediately after the supply of the developer onto the substrate W has been stopped, the substrate W is rotated at high speed, for example, at the rotation speed of 2,000 rpm to 3,000 rpm for a short time period, for example, just one second, and thereafter, switched to low speed, for example, at the rotation speed of 300 rpm to 500 rpm. Incidentally, during the time period of the substrate W being rotated, the inside cup 96 is lifted.

Due to that the substrate W is rotated after the development process has been ended, the developer on the surface of the substrate W is dispersed by the centrifugal force to be removed. Then, at the time point at which there is no interference fringe seen on the surface of the substrate W, that is, at the time point at which there is no interference fringe detected on the surface of the substrate W by the interference fringe detecting mechanism that is formed of the CCD camera, the monochromator, the CPU and the memory, while the substrate W further continues to be rotated, for example, while the substrate W is being rotated at the rotation speed of, for example, 1,000 rpm, the DI water discharge nozzle 110 is turned, the tip end outlet of the DI water discharge nozzle 110 is moved to the position right above the center of the substrate W, and the DI water is discharged and fed onto the center of the substrate W from the tip end outlet of the DI water discharge nozzle 110. In other embodiments, the time point is determined based on the interference fringe being characterized by a predetermined level. At this time, it is preferable that immediately after the start of rinsing, the substrate W is rotated at high speed for a moment, and thereafter the speed is reduced. When the rinsing process is ended, after the DI water has been discharged onto the center of the substrate W from the tip end outlet of the DI water discharge nozzle 110, for example, for about 10 seconds to 15 seconds, the supply of the DI water onto the substrate W is stopped, the DI water discharge nozzle 110 is turned and returned to the original waiting position as illustrated in FIG. 6, and the rotation speed of the substrate W is switched to high speed, to dry the substrate W by spin-drying. On this occasion, the inside cup 96 is lifted. When drying of the substrate W is ended, the substrate W is removed from the spin chuck 90 to be transported out of the apparatus.

Also in the processing apparatus illustrated in FIGS. 6 to 8, since in the state that a less developer remains on the resist film on the surface of the substrate W or in the state in which there is no developer present on the resist film, the DI water is fed onto the resist film on the surface of the substrate W to conduct rinsing, in the same manner as in the apparatus illustrated in FIGS. 1 to 3, the generation of stain-like defects on the resist film surface caused by the remaining developer on the resist film is prevented. The time point at which the substrate has been rotated for 60 seconds to 120 seconds after the processing corresponds to the time point at which there is no interference fringe seen on the substrate surface. Thus, by going to the rinsing process at the time point at which there is no interference fringe or a reduced interference fringe seen on the substrate surface, the number of defects can be significantly reduced. From experiment results, when going to the rinsing process after the substrate has been rotated for 120 seconds after the development process, the number of defects could be reduced one-tenth that in the case of going to the rinsing process immediately after the development process. In addition, the development reaction still proceeds even if more developer than necessary is not spread on the resist film, so that by adjusting the time of going to the rinsing process, the pattern line width of the resist film can be controlled.

Incidentally, in the processing apparatus illustrated in FIGS. 6 to 8, in the same manner as in the processing apparatus illustrated in FIGS. 4 and 5, it is preferable that there is disposed in the vicinity of the outside cup 98 a gas jet nozzle blowing out a drying gas, for example, a nitrogen gas onto the substrate W from a jet hole at a tip end. Furthermore, it is preferable that on the occasion when the substrate W is rotated after the processing to remove the developer, the nitrogen gas is blown out to the center of the substrate W from the jet hole of the gas jet nozzle; or while the nitrogen gas is being blown out onto the surface of the substrate W from the jet hole of the gas jet nozzle, the jet hole of the gas jet nozzle is scanned from the position of opposed to the center of the substrate W to the position of opposed to the circumferential edge of the substrate W. Moreover, it is preferable that the rotation speed of the substrate is variable.

While the present invention has been described with respect to particular embodiments and specific examples thereof, it should be understood that other embodiments may fall within the spirit and scope of the invention. The scope of the invention should, therefore, be determined with reference to the appended claims along with their full scope of equivalents.

What is claimed is:

1. A substrate processing method comprising:
performing a development process comprising:
rotating a substrate about a vertical axis in a horizontal posture; and
feeding a developer onto a resist film having been exposed and formed on a surface of the substrate, thereby processing the resist film;
continuing the rotating the substrate about the vertical axis in the horizontal posture, thereby dispersing the developer on the surface of the substrate;
detecting an interference fringe on the surface of the substrate;
determining that the interference fringe is at a predetermined level;
thereafter performing a rinsing process comprising feeding a rinse onto the processed resist film while the substrate is being rotated about the vertical axis in the horizontal posture; and
drying the rinsed and processed resist film by rotating the substrate about the vertical axis in the horizontal posture.

2. The substrate processing method of claim 1 wherein performing the development process further comprises moving a slit nozzle having a slit-like outlet at a lower end face linearly in a direction orthogonal to the slit-like outlet while the developer is discharged onto the resist film on the substrate surface from the slit-like outlet.

3. The substrate processing method of claim 2 wherein the developer is spread forming a continuous film all over the surface of the resist film.

4. The substrate processing method of claim 2 wherein rotating a substrate about a vertical axis in a horizontal posture is terminated prior to feeding the developer.

5. The substrate processing method of claim 1 wherein performing the development process further comprises:
discharging the developer onto the center of the substrate from the tip end outlet of the straight nozzle while rotating the substrate; and
continuing rotating the substrate after the development process, thereby dispersing the developer on the surface of the substrate.

6. The substrate processing method of claim 1 wherein the drying the rinsed and processed resist film further comprises feeding a drying gas onto the center of the substrate while rotating the substrate.

7. The substrate processing method of claim 1 further comprising scanning a position of feeding the drying gas from the center of the substrate to a circumferential edge thereof.

8. The substrate processing method of claim 1 wherein the predetermined level is associated with no interference fringe.

9. A substrate processing apparatus comprising:
a substrate holder configured to hold the substrate in a horizontal posture;
a substrate rotation device coupled to the substrate holder and configured to rotate the substrate about a vertical axis;
a developer discharge nozzle configured to discharge a developer onto a resist film having been exposed and formed on a surface of the substrate held by the substrate holder; and
a rinse discharge nozzle configured to discharge a rinse onto the resist film;
an interference fringe detection system configured to image the surface of the substrate and detect the signal level associated with interference fringes on the substrate surface; and
a control system coupled to the substrate rotation device, the developer discharge nozzle, the rinse discharge nozzle, and the interference fringe detection system, the control system configured to determine that the signal level associated with the interference fringes is equal to or less than a predetermined level and thereafter initiate the discharge of the rinse onto the resist film.

10. The substrate processing apparatus of claim 9 wherein the signal level associated with the interference fringes is associated with no interference fringes.

11. The substrate processing apparatus of claim 9 wherein the control system is further configured to rotate the substrate after the developer has been discharged onto the resist film.

12. The substrate processing apparatus of claim 9 wherein the developer discharge nozzle comprises a slit nozzle having a slit-like outlet at a lower end face.

13. The substrate processing apparatus of claim 12 wherein the control system is further configured to terminate rotating the substrate prior to discharging the developer.

14. The substrate processing apparatus of claim 9 wherein the developer discharge nozzle comprises a straight nozzle having a tip end outlet.

15. The substrate processing apparatus of claim 9 further comprising a gas jet nozzle configured to provide a drying gas onto the resist film.

16. The substrate processing apparatus of claim 15 wherein the control system is further configured to scan the gas jet nozzle from the center of the substrate to a position opposing the circumferential edge of the substrate.

17. A substrate processing apparatus comprising:
substrate holding means for holding a substrate in a horizontal posture;
substrate rotating means causing the substrate that is held by the substrate holding means to rotate about a vertical axis;
a developer discharge nozzle discharging a developer onto a resist film having been exposed and formed on a surface of the substrate held by the substrate holding means; and
a rinse discharge nozzle discharging a rinse onto a resist film having been processed and formed on the substrate surface,
the substrate processing apparatus further comprising:
interference fringe detecting means for imaging the surface of the substrate to detect the presence or absence of the interference fringe on the substrate surface from the imaged data thereof; and
control means for controlling each of the substrate rotating means, the developer discharge nozzle, and the rinse discharge nozzle such that while the substrate is being rotated by the substrate rotating means, after the developer has been discharged onto the resist film having been exposed and formed on the substrate surface from the developer discharge nozzle to process the resist film, the substrate continues to be rotated, and thus the developer on the surface of the substrate is dispersed by a centrifugal force to be removed, and at a time point at which there is no interference fringe detected on the substrate surface by the interference fringe detecting means, a rinse is discharged onto the resist film having been processed and formed on the substrate surface from the rinse discharge nozzle to conduct rinsing.

18. The substrate processing apparatus of claim 17 wherein the developer discharge nozzle is a slit nozzle having a slit-like outlet at a lower end face, and with respect to a substrate in a still state of being held by the substrate holding means or a substrate in rotation at low speed, while being moved linearly in a direction orthogonal to the slit-like outlet, discharging the developer onto the resist film on the substrate surface from the slit-like outlet, to spread the developer forming a continuous film all over the surface of the resist film.

19. The substrate processing apparatus of claim 17 wherein the developer discharge nozzle is a straight nozzle discharging the developer from the tip end outlet onto the center of the substrate that is held by the substrate holding means and rotated at low speed by the substrate rotating means, to spread the developer all over the surface of the resist film on the substrate surface to apply the developer.

20. The substrate processing apparatus of claim 17 further comprising a gas jet nozzle blowing out a drying gas onto the resist film having been processed that is formed on the substrate surface, wherein the gas jet nozzle, while a drying gas is being blown out onto the surface of the substrate from a jet hole thereof, is scanned from a position in which the jet hole is opposed to the center of the substrate to a position in which it is opposed to the circumferential edge of the substrate.
